(19) United States
(12) Patent Application Publication
(10) Pub. No.: US 2012/0080531 A1
(43) Pub. Date: Apr. 5, 2012

(54) THERMOSTAT CONFIGURED FOR PROVIDING EVALUATION OF A TEMPERATURE CONTROL EQUIPMENT AND METHOD THEREOF

(76) Inventor: Haorong Li, Omaha, NE (US)

(21) Appl. No.: 12/897,783

(22) Filed: Oct. 5, 2010

(51) Int. Cl. G05D 23/00; G06F 15/00

(52) U.S. Cl. 236/47; 702/182

(57) ABSTRACT

A method for evaluating a temperature control equipment of a building. The temperature control equipment is communicatively coupled with a thermostat. The method may comprise calculating an ideal design temperature difference (DTD) for temperature control of the building; calculating an actual DTD associated with the temperature control equipment, the actual DTD being calculated at least partially based on: an equipment off time during a temperature control equipment work cycle, an equipment on time during the temperature control equipment work cycle, an ambient temperature, and a set point temperature of the thermostat; and evaluating the temperature control equipment based on the ideal DTD and the actual DTD, the temperature control equipment being evaluated to determine whether the temperature control equipment is at least one of: oversized for the building, undersized for the building, or generally matches with a temperature control requirement of the building.

### TECHNICAL FIELD

The disclosure generally relates to the field of electronic thermostats, particularly to a thermostat capable of providing evaluation of temperature control equipment.

### BACKGROUND

A thermostat is a device for regulating the temperature of a building system so that the temperature is maintained near a desired set point temperature. The thermostat does this by switching temperature/climate control equipment (e.g., heating or cooling devices) on or off, to maintain the temperature around the desired set point. The duration of which the temperature control equipment changes from a first state (e.g., OFF state) to a second state (e.g., ON state) till the next time the temperature control equipment changes from the first state (e.g., OFF state) to the second state (e.g., ON state) may be referred to as a work cycle.

### SUMMARY

The present disclosure is directed to a method for evaluating a temperature control equipment of a building. The temperature control equipment is communicatively coupled with a thermostat. The method may comprise calculating an ideal design temperature difference (DTD) for temperature control of the building; calculating an actual DTD associated with the temperature control equipment, the actual DTD being calculated at least partially based on: an equipment off time during a temperature control equipment work cycle, an equipment on time during the temperature control equipment work cycle, an ambient temperature, and a set point temperature of the thermostat; and evaluating the temperature control equipment based on the ideal DTD and the actual DTD, the temperature control equipment being evaluated to determine whether the temperature control equipment is at least one of: oversized for the building, undersized for the building, or generally matches with a temperature control requirement of the building.

A further embodiment of the present disclosure is directed to a thermostat communicatively coupled with a temperature control equipment of a building. The thermostat may include a temperature control module configured for determining: an equipment off time during a temperature control equipment work cycle, an equipment on time during the temperature control equipment work cycle, an ambient temperature, and a set point temperature of the thermostat. The thermostat may also include a computing module configured for calculating an ideal design temperature difference (DTD) for temperature control of the building, the computing module further configured for calculating an actual DTD associated with the temperature control equipment, the actual DTD being calculated at least partially based on: the equipment off time during a temperature control equipment work cycle, the equipment on time during the temperature control equipment work cycle, the ambient temperature, and the set point temperature of the thermostat. The thermostat may further include an evaluation module configured for evaluating the temperature control equipment based on the ideal DTD and the actual DTD, the temperature control equipment being evaluated to determine whether the temperature control equipment is at least one of: oversized for the building, undersized for the building, or generally matches with a temperature control requirement of the building.

An additional embodiment of the present disclosure is directed to a method for evaluating a temperature control equipment of a building. The method may comprise calculating an ideal design temperature difference (DTD) for temperature control of the building; calculating an actual DTD associated with the temperature control equipment, the actual DTD being calculated at least partially based on: an equipment off time during a temperature control equipment work cycle, an equipment on time during the temperature control equipment work cycle, an ambient temperature, and a set point temperature; and evaluating the temperature control equipment based on the ideal DTD and the actual DTD, the temperature control equipment being evaluated to determine whether the temperature control equipment is at least one of: oversized for the building, undersized for the building, or generally matches with a temperature control requirement of the building.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for providing evaluation of a temperature control (HVAC) equipment;

FIG. 2 is a flow diagram illustrating a method for evaluating the HVAC equipment based on an actual design temperature difference (DTD) and an ideal DTD; and

FIG. 3 is an illustration depicting a thermostat configured for providing evaluation of a temperature control (HVAC) equipment.

### DETAILED DESCRIPTION

Reference will now be made in detail to the subject matter disclosed, which is illustrated in the accompanying drawings.

The present disclosure is directed to a method and a thermostat configured for providing evaluation of temperature/climate control equipments (may also be referred to as HVAC equipments). A relationship between a building/room and the HVAC equipment utilized to control the climate of the building is established. Such a relationship may provide information regarding whether the HVAC equipment is sufficient enough to provide temperature control for the building/room. Utilizing such information, a user/owner of the building/room may decide whether the current HVAC equipment needs to be downsized or upgraded.

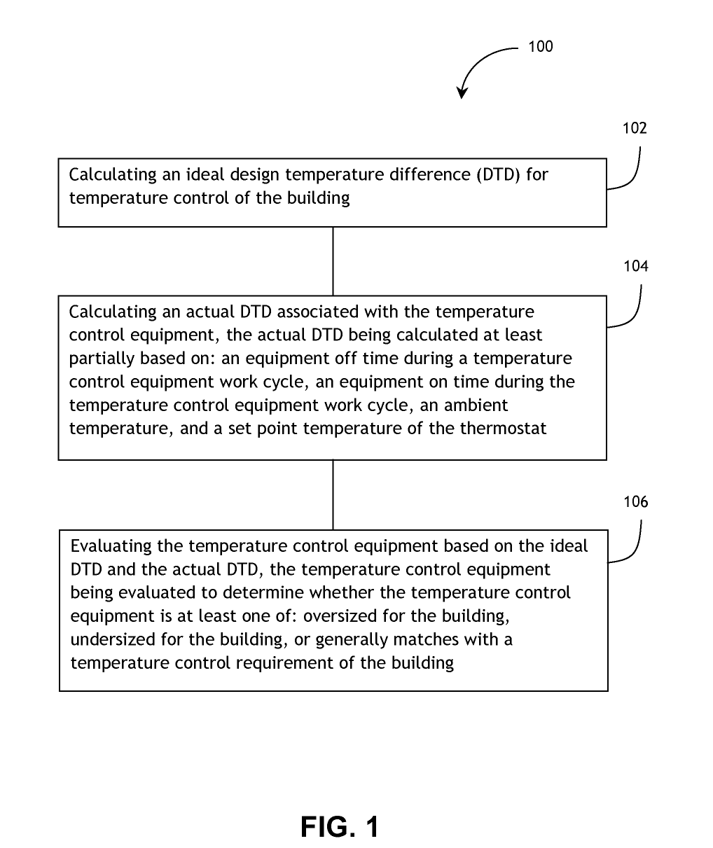

Referring to FIG. 1, a flow diagram illustrating a method 100 for HVAC equipment evaluation is shown. Step 102 may calculate an ideal design temperature difference (DTD) for temperature control of the building. The ideal DTD may be calculated according to the climate information obtained based on the location of the building. For example, if the building is located in a region where outdoor temperatures may reach −20° F. in winter while the desirable indoor temperatures should be kept around 70° F., then the ideal/supposed design temperature difference for the heating equipment should be approximately the different between −20° F. and 70° F., which is 90° F. On the other hand, if the outdoor temperatures may reach 100° F. in summer while the desirable indoor temperatures should still be kept around 70° F., then the ideal/supposed design temperature difference for the cooling equipment should be approximately the different between 100° F. and 70° F., which is 30° F.

While the ideal DTDs may vary from location to location, they may be calculated based on information readily available. For instance, ASHRAE (American Society of Heating, Refrigerating and Air-Conditioning Engineers) provides design conditions for winters and summers of various regions throughout the United States and the world. For a particular region, if the design condition for winter provided by ASHRAE is −20° F. and the set point temperature of the thermostat is 70° F., then DTD_{ideal,heating} of 90° F. may be calculated. Similarly, if the design condition for summer provided by ASHRAE is 100° F. and the set point temperature of the thermostat is 70° F., then DTD_{ideal,cooling} of 30° F. may be calculated. It is contemplated that design conditions for a particular region may be obtained via various other sources. For example, local weather stations may also provide such information.

Step 104 may calculate an actual DTD for either the heating equipment or the cooling equipment (whichever is operating at the time). The actual DTD may be compared against the ideal DTD for evaluation of the HVAC equipment. The DTD for either the heating equipment or the cooling equipment may be calculated based on the equipment OFF time during a work cycle t_{off}, the equipment ON time during the work cycle tₒₙ, an ambient temperature Tₒₐ (e.g., an outdoor/exterior temperature), and a set point temperature of the thermostat Tₛₚ. In one embodiment, the DTD is calculated according to equation:

$$DTD = \frac{{t}_{on} + {t}_{off}}{{t}_{on}} ( {T}_{sp} - {T}_{oa} )$$

Step 106 may evaluate the HVAC equipment based on the calculated actual DTDs and the ideal DTDs. For instance, if the DTD calculated during the operation of a heating equipment is noticeably greater than the value of the ideal DTD for heating, then the heating equipment may be oversized; otherwise if the DTD calculated during the operation of a heating equipment is noticeably less than the value of the ideal DTD for heating, then the heating equipment may be undersized and/or degraded. Similarly, if the DTD calculated during the operation of a cooling equipment is noticeably greater than the value of the ideal DTD for cooling, then the cooling equipment may be oversized; otherwise if the DTD calculated during the operation of a cooling equipment is noticeably less than the value of the ideal DTD for cooling, then the cooling equipment may be undersized and/or degraded.

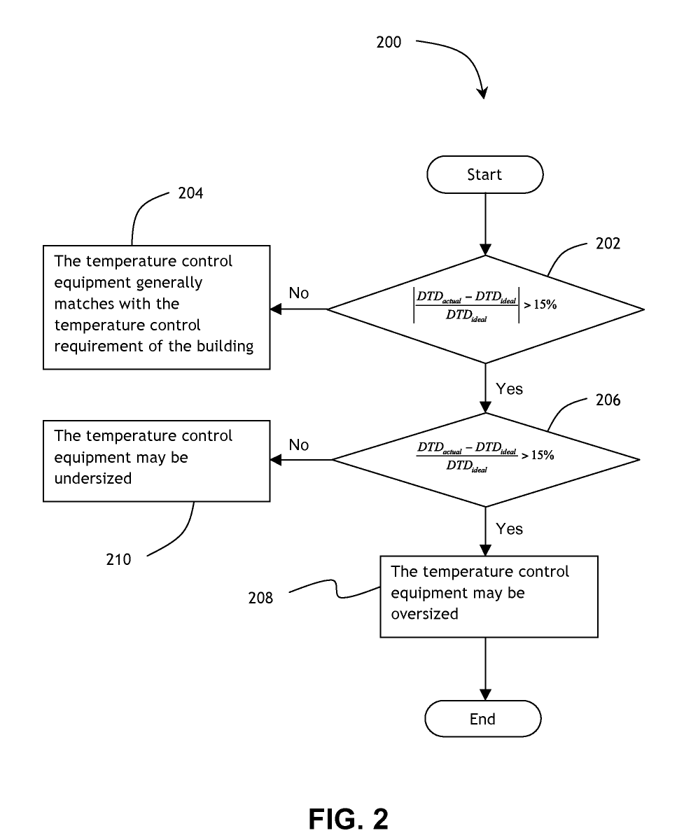

Referring to FIG. 2, a flow diagram illustrating a method 200 for evaluating the HVAC equipment based on the calculated actual DTD and the ideal DTD is shown. It is understood that method 200 may be utilized for evaluation of the heating equipment and/or the cooling equipment. It is also understood that the actual DTD (denoted as DTD_{actual}) and the ideal DTD (denoted as DTD_{deal}) represent the corresponding values for either the heating equipment or the cooling equipment, whichever is the subject of the evaluation.

In one embodiment, step 202 determines whether a significant/noticeable difference exists between DTD_{actual} and DTD_{ideal}. For example, the value of

$$\vert \frac{{DTD}_{actual} - {DTD}_{ideal}}{{DD}_{ideal}} \vert$$

may be calculated and compared against a predetermined threshold (e.g., a percentage value, such as 15% in a particular implementation). If the result is not above the threshold, the difference may be considered not noticeable (insignificant), which may imply that the size of the HVAC equipment generally matches with the temperature control requirement of the building, and no equipment change may be necessary (as indicated in step 204). Otherwise, if the result is above the threshold, the difference may be considered noticeable, indicating that the HVAC equipment may need to be upgraded or downsized in order to satisfy the temperature control requirement of the building.

Step 206 determines whether the HVAC equipment may need to be upgraded or downsized. In one embodiment, the value of

$$\frac{{DTD}_{actual} - {DTD}_{ideal}}{{DD}_{ideal}}$$

may be calculated and compared against a predetermined threshold (e.g., a percentage value, such as 15% in a particular implementation). If the result is above the threshold, then DTD_{actual} may be considered noticeably greater than DTD_{ideal}, and the HVAC equipment may be oversized for the temperature control requirement of the building (as indicated in step 208). Otherwise, if the result is less than or equal to the threshold, then DTD_{actual} may be considered noticeably less than DTD_{ideal}, and the HVAC equipment may be undersized for the temperature control requirement of the building (as indicated in step 210).

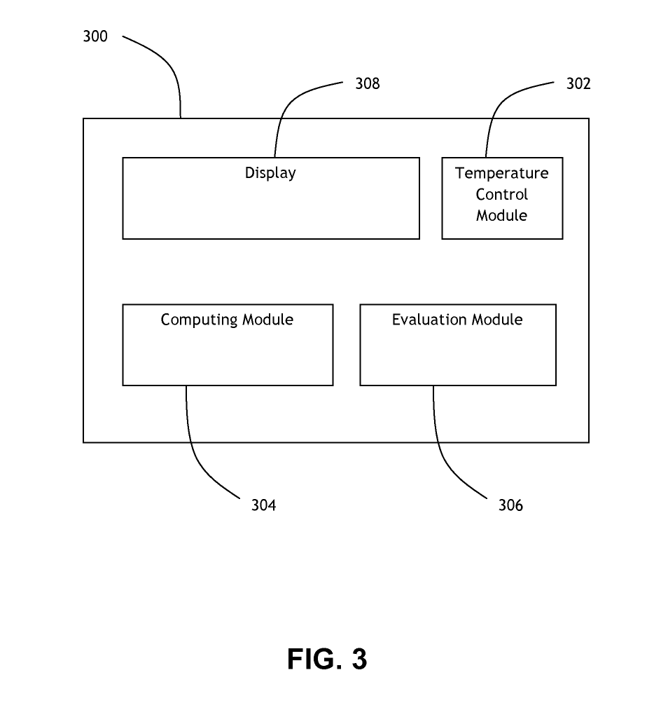

Referring to FIG. 3, an illustration depicting a thermostat 300 capable of providing evaluation of an HVAC equipment is shown. The thermostat 300 may include a temperature control module 302 for controlling/maintaining the temperature near a desired set point temperature. For example, the temperature control module may turn a piece of equipment (e.g., heating or cooling devices) on or off to maintain the temperature around the desired set point. In one embodiment, the temperature control module 302 is configured for determining an equipment OFF time during a work cycle, an equipment ON time during the work cycle, a set point temperature of the thermostat, and an ambient temperature (e.g., utilizing an outdoor temperature sensor, or receiving the current outdoor temperature from a weather station via a wired/wireless network).

The thermostat 300 further includes a computing module 304 configured for calculating DTD_{ideal} and DTD_{actual} as previously described. In one embodiment, the design condition/temperature for calculating DTD_{ideal} may be obtained via a network. Alternatively, the thermostat 300 may include a lookup table/file/database for determining the design condition/temperature based on the location of the building where the thermostat 300 is installed. It is understood that the thermostat 300 may be utilized for evaluation of the heating equipment and/or the cooling equipment. It is also understood that DTD_{ideal} and DTD_{actual} represent the corresponding values for either the heating equipment or the cooling equipment, whichever is the subject of the evaluation.

The thermostat 300 further includes an evaluation module 306 configured for providing evaluation of the HVAC equipment. In one embodiment, the HVAC equipment is evaluated based on the difference between DTD_{actual} and DTD_{ideal}. For example, the value of

$$\vert \frac{{DTD}_{actual} - {DTD}_{ideal}}{{DD}_{ideal}} \vert$$

may be calculated and compared against a predetermined threshold. If the result is not above the threshold, the difference may be considered not noticeable, which may imply that the size of the HVAC equipment generally matches with the temperature control requirement of the building, and no equipment change may be. Otherwise, if the result is above the threshold, the difference may be considered noticeable, indicating that the HVAC equipment may need to be upgraded or downsized in order to satisfy the temperature control requirement of the building.

The evaluation module 306 may further determine whether the HVAC equipment needs to be upgraded or downsized. For example, the value of

$$\frac{{DTD}_{actual} - {DTD}_{ideal}}{{DD}_{ideal}}$$

may be calculated and compared against a predetermined threshold. If the result is above the threshold, then DTD_{actual} may be considered noticeably greater than DTD_{ideal}, and the HVAC equipment may be oversized for the temperature control requirement of the building. Otherwise, if the result is less than or equal to the threshold, then DTD_{actual} may be considered noticeably less than DTD_{ideal} and the HVAC equipment may be undersized for the temperature control requirement of the building.

The thermostat 300 may further include a display 308. The display 308 may serve as a user interface and/or providing information regarding the evaluation of the HVAC equipment. It is contemplated that information regarding the evaluation results may also be presented via electronic messages (e.g., text messages, electronic mails, or the like). Furthermore, in an event where immediate attention may be needed, a notification may be sent to indicate the issue that need to be addressed. The evaluation results and/or notifications may be provided in the forms of an audible signal (e.g., an alarm or a speaker communicatively coupled with the thermostat 300), a visual signal (e.g., via the display 308 or LED indicators), and/or an electronic data signal (e.g., text messages, electronic mails, or the like).

It is contemplated that actions may be taken based on the evaluation results. For example, if the heating or cooling system is determined to be oversized compared to the temperature control requirement of the building, then a smaller heating or cooling system may be recommended to replace the current one. Additionally/alternatively, soft-repairs (e.g., smart control strategies) may be applied to the control logics (e.g., firmware) of the thermostat and/or the heating or cooling system to virtually downsize the system. In another example, if the heating or cooling system is determined to be undersized by design, then a larger heating or cooling system may be recommended to replace the current one. Additionally/alternatively, the building envelop systems (insulation, windows, doors and ceiling) may be upgraded. Furthermore, if the heating or cooling system is determined to be degraded, repair/service may be recommended.

It is contemplated that the temperature control module 302, the computing module 304 and the evaluation module 306 may be implemented as separate and interconnected hardware components. Alternatively, they may correspond to various functional aspects of an integrated control device. It is understood that each module may be implemented as either a hardware component or a firmware/software component without departing from the spirit and scope of the present disclosure.

It is believed that the system and method of the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory.

What is claimed is:

1. A method for evaluating a temperature control equipment of a building, the temperature control equipment being communicatively coupled with a thermostat, the method comprising:
calculating an ideal design temperature difference (DTD) for temperature control of the building;
calculating an actual DTD associated with the temperature control equipment, the actual DTD being calculated at least partially based on: an equipment off time during a temperature control equipment work cycle, an equipment on time during the temperature control equipment work cycle, an ambient temperature, and a set point temperature of the thermostat; and
evaluating the temperature control equipment based on the ideal DTD and the actual DTD, the temperature control equipment being evaluated to determine whether the temperature control equipment is at least one of: oversized for the building, undersized for the building, or generally matches with a temperature control requirement of the building.

2. The method of claim 1, wherein the ideal DTD is calculated as a difference between: a design condition for a location of the building, and the set point temperature of the thermostat.

3. The method of claim 1, wherein the actual DTD is calculated based on the equipment off time during the temperature control equipment work cycle (t_{off}), the equipment on time during the temperature control equipment work cycle (tₒₙ), the ambient temperature (Tₒₐ), and the set point temperature of the thermostat (Tₛₚ) according to equation:
$$DTD = \frac{{t}_{on} + {t}_{off}}{{t}_{on}} ( {T}_{sp} - {T}_{oa} ) .$$

4. The method of claim 1, wherein evaluating the temperature control equipment based on the ideal DTD and the actual DTD further comprises:
calculating a difference between the ideal DTD and the actual DTD;
indicating the temperature control equipment generally matches with the temperature control requirement of the building when the difference between the ideal DTD and the actual DTD is insignificant;
indicating the temperature control equipment is oversized for the building when the actual DTD is noticeably greater than the ideal DTD; and
indicating the temperature control equipment is undersized for the building when the actual DTD is noticeably less than the ideal DTD.

5. The method of claim 4, wherein the difference between the ideal DTD (DTD_{ideal}) and the actual DTD (DTD_{actual}) is calculated according to equation:
$$\vert \frac{{DTD}_{actual} - {DTD}_{ideal}}{{DTD}_{ideal}} \vert .$$

6. The method of claim 4, wherein the difference between the ideal DTD and the actual DTD is insignificant when
$$\vert \frac{{DTD}_{actual} - {DTD}_{ideal}}{{DD}_{ideal}} \vert$$
is below a predetermined threshold.

7. The method of claim 4, wherein the actual DTD is noticeably greater than the ideal DTD when
$$\frac{{DTD}_{actual} - {DTD}_{ideal}}{{DTD}_{ideal}}$$
is above a predetermined threshold.

8. The method of claim 4, wherein the actual DTD is noticeably less than the ideal DTD when
$$\frac{{DTD}_{actual} - {DTD}_{ideal}}{{DTD}_{ideal}}$$
is below a predetermined threshold.

9. The method of claim 1, wherein the temperature control equipment is at least one of: a heating equipment, and a cooling equipment.

10. A thermostat, the thermostat communicatively coupled with a temperature control equipment of a building, the thermostat comprising:
a temperature control module configured for determining: an equipment off time during a temperature control equipment work cycle, an equipment on time during the temperature control equipment work cycle, an ambient temperature, and a set point temperature of the thermostat;
a computing module configured for calculating an ideal design temperature difference (DTD) for temperature control of the building, the computing module further configured for calculating an actual DTD associated with the temperature control equipment, the actual DTD being calculated at least partially based on: the equipment off time during a temperature control equipment work cycle, the equipment on time during the temperature control equipment work cycle, the ambient temperature, and the set point temperature of the thermostat;
an evaluation module configured for evaluating the temperature control equipment based on the ideal DTD and the actual DTD, the temperature control equipment being evaluated to determine whether the temperature control equipment is at least one of: oversized for the building, undersized for the building, or generally matches with a temperature control requirement of the building.

11. The thermostat of claim 10, wherein the ideal DTD is calculated as a difference between: a design condition for a location of the building, and the set point temperature of the thermostat.

12. The thermostat of claim 10, wherein the actual DTD is calculated based on the equipment off time during the temperature control equipment work cycle (t_{off}), the equipment on time during the temperature control equipment work cycle (tₒₙ), the ambient temperature (Tₒₐ), and the set point temperature of the thermostat (Tₛₚ) according to equation:
$$DTD = \frac{{t}_{on} + {t}_{off}}{{t}_{on}} ( {T}_{sp} - {T}_{oa} ) .$$

13. The thermostat of claim 10, wherein the evaluation module is configured for evaluating the temperature control equipment by performing the steps of:
calculating a difference between the ideal DTD and the actual DTD;
indicating the temperature control equipment generally matches with the temperature control requirement of the building when the difference between the ideal DTD and the actual DTD is insignificant;
indicating the temperature control equipment is oversized for the building when the actual DTD is noticeably greater than the ideal DTD; and
indicating the temperature control equipment is undersized for the building when the actual DTD is noticeably less than the ideal DTD.

14. The thermostat of claim 13, wherein the difference between the ideal DTD (DTD_{ideal}) and the actual DTD (DTD_{actual}) is calculated according to equation:
$$\vert \frac{{DTD}_{actual} - {DTD}_{ideal}}{{DD}_{ideal}} \vert .$$

15. The thermostat of claim 13, wherein the difference between the ideal DTD and the actual DTD is insignificant when
$$\vert \frac{{DTD}_{actual} - {DTD}_{ideal}}{{DTD}_{ideal}} \vert$$
is below a predetermined threshold.

16. The thermostat of claim 13, wherein the actual DTD is noticeably greater than the ideal DTD when
$$\frac{{DTD}_{actual} - {DTD}_{ideal}}{{DTD}_{ideal}}$$
is above a predetermined threshold.

17. The thermostat of claim 13, wherein the actual DTD is noticeably less than the ideal DTD when
$$\frac{{DTD}_{actual} - {DTD}_{ideal}}{{DTD}_{ideal}}$$
is below a predetermined threshold.

18. The thermostat of claim 10, wherein the temperature control equipment is at least one of: a heating equipment, and a cooling equipment.

19. A method for evaluating a temperature control equipment of a building, the method comprising:
calculating an ideal design temperature difference (DTD) for temperature control of the building;
calculating an actual DTD associated with the temperature control equipment, the actual DTD being calculated at least partially based on: an equipment off time during a temperature control equipment work cycle, an equipment on time during the temperature control equipment work cycle, an ambient temperature, and a set point temperature; and
evaluating the temperature control equipment based on the ideal DTD and the actual DTD, the temperature control equipment being evaluated to determine whether the temperature control equipment is at least one of: oversized for the building, undersized for the building, or generally matches with a temperature control requirement of the building.

20. The method of claim 19, wherein said evaluating the temperature control equipment of the building is performed by a thermostat communicatively coupled with the temperature control equipment.
